(19) United States
(12) Patent Application Publication
(10) Pub. No.: US 2017/0298737 A1
(43) Pub. Date: Oct. 19, 2017

(54) TURBOMACHINE

(71) Applicant: HONDA MOTOR CO., LTD., Tokyo (JP)

(72) Inventors: Naoki KUNO, Wako (JP); Naoki ITOH, Wako (JP)

(73) Assignee: HONDA MOTOR CO., LTD., Tokyo (JP)

(21) Appl. No.: 15/478,249

(22) Filed: Apr. 4, 2017

(30) Foreign Application Priority Data
Apr. 19, 2016 (JP) 2016-083766

(51) Int. Cl. F01D 5/04; F01D 25/24; F02B 37/00

(52) U.S. Cl. CPC F01D 5/048; F01D 25/24; F05D 2220/40; F02B 37/00

(57) ABSTRACT

A turbomachine includes a turbine impeller having a rotational axis, a first end portion, and a second end portion. The turbine impeller includes main blades and splitters. Each of the main blades has a blade first edge provided at the first end portion and a blade second edge provided at the second end portion and extends from the blade first edge to the blade second edge. Each of the splitters has a splitter first edge and a splitter second edge and extends from the splitter first edge to the splitter second edge. The blade first edge and the splitter first edge are arranged on a plane perpendicular to the rotational axis. The splitter second edge is positioned between the splitter first edge and the blade second edge along the rotational axis. The main blades and the splitters are arranged alternately in a circumferential direction around the rotational axis.

### CROSS-REFERENCE TO RELATED APPLICATIONS

The present application claims priority under 35 U.S. C. §119 to Japanese Patent Application No. 2016-083766, filed Apr. 19, 2016. The contents of this application are incorporated herein by reference in their entirety.

### BACKGROUND OF THE INVENTION

### Field of the Invention

The present invention relates to a turbomachine.

### Discussion of the Background

As a turbocharger applied to an internal combustion engine, a centrifugal type is widely used. Since a turbomachine such as a turbocharger particularly requires an agile response characteristic, so-called turbo lag which is a delay in response during acceleration becomes a problem. To suppress turbo lag, it is necessary to reduce the moment of inertia (inertia) of a rotor (impeller) in an exhaust turbine part and an intake compressor part.

Moreover, such a turbocharger requires a wide flow rate range, so that the turbine efficiency does not deteriorate even when the rate of exhaust flow supplied to the exhaust turbine part varies largely. In order to respond to this need, a choke margin needs to be increased, by varying the curve angle of an impeller and enlarging a throat area, for example.

Various techniques have already been proposed to meet the above-mentioned needs of a turbocharger.

For example, techniques have been proposed in which a passageway of an exhaust flow supplied to an exhaust turbine part is divided into two scroll passageways to allow the exhaust flow to hit the impeller of the exhaust turbine, and in a downstream area where the two divided exhaust flows merge, half-blade impellers are placed alternately to reduce the number of impellers to half of that on the upstream side (see Patent Japanese Patent Application Publication No. 2007-192172 and Japanese Patent No. 5762641).

### SUMMARY OF THE INVENTION

According to one aspect of the present invention, a turbomachine includes a turbine impeller inside a turbine housing, in which: the turbine impeller has a main blade that extends from a predefined front edge to rear edge, and a splitter that has its own front edge position aligned with the front edge position of the main blade, extends from the own front edge position to an intermediate position that does not reach the rear edge position of the main blade, and ends at its own rear edge, multiple main blades and splitters being arranged alternately in the circumferential direction; and the turbine housing has a scroll passageway that is arranged in such a manner as to surround the outer periphery of the turbine impeller between an exhaust inlet and outlet, and that forms a single gas circulation passage having a gas inlet passage leading to the turbine impeller.

According to another aspect of the present invention, a turbomachine includes a turbine impeller and a turbine housing. The turbine impeller has a rotational axis, a first end portion, and a second end portion opposite to the first end along the rotational axis. The turbine impeller includes main blades and splitters. Each of the main blades has a blade first edge provided at the first end portion and a blade second edge provided at the second end portion and extends from the blade first edge to the blade second edge. Each of the splitters has a splitter first edge and a splitter second edge and extends from the splitter first edge to the splitter second edge. The blade first edge and the splitter first edge are arranged on a plane perpendicular to the rotational axis. The splitter second edge is positioned between the splitter first edge and the blade second edge along the rotational axis. The main blades and the splitters are arranged alternately in a circumferential direction around the rotational axis. The turbine housing accommodates the turbine impeller in the turbine housing. The turbine housing includes a scroll passageway arranged to surround an outer periphery of the turbine impeller to define a single gas circulation passage leading to the turbine impeller.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a cross-sectional view of a turbomachine as one embodiment of the present invention.

FIG. 2 is a plan view showing an example of a turbine impeller of the turbomachine of FIG. 1.

FIG. 3 is a side view of the turbine impeller of FIG. 2 from a viewpoint where one splitter is placed at the center.

FIG. 4 is a side view of the turbine impeller of FIG. 2 from a viewpoint where one main blade is placed at the center.

FIG. 5 is a view of a meridional cross-section of the turbine impeller of FIG. 2.

FIG. 6 is a view of a partial cross-section of the turbine impeller of FIG. 2.

### DESCRIPTION OF THE EMBODIMENTS

The embodiment(s) will now be described with reference to the accompanying drawings, wherein like reference numerals designate corresponding or identical elements throughout the various drawings.

Hereinafter, an embodiment of the present invention is described in detail with reference to the drawings. Note that a whole turbomachine as one embodiment of the present invention will first be described in terms of general configuration and effects, and then a turbine impeller which is a main part of the present invention will be described in detail.

(Turbomachine as One Embodiment of Present Invention)

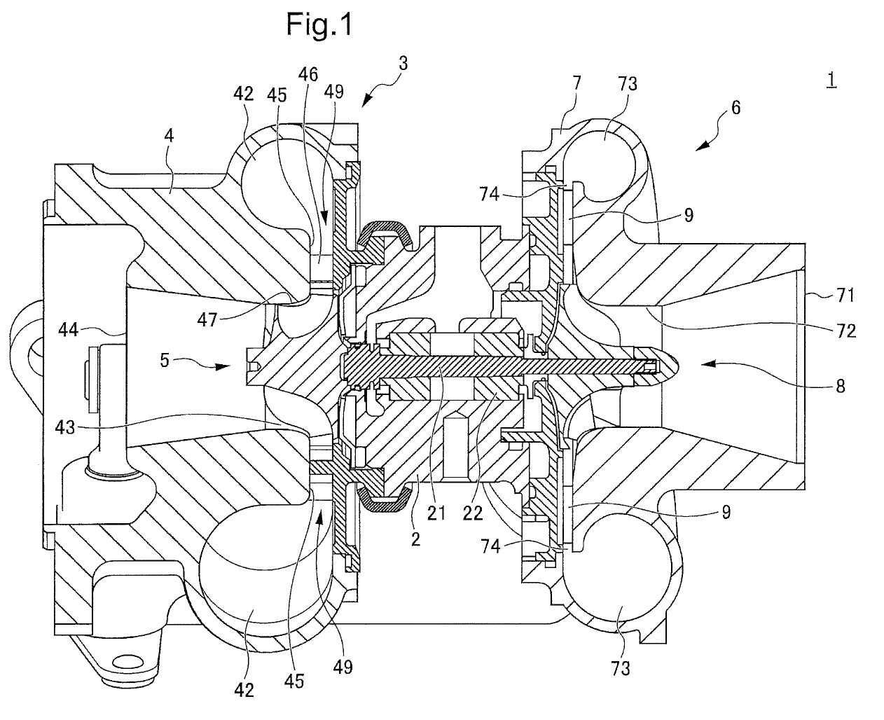

FIG. 1 is a cross-sectional view of a turbomachine as one embodiment of the present invention.

A turbocharger 1 as a turbomachine includes a turbine 3 as an exhaust turbine part, a compressor 6 as an intake compressor part, and a rotary shaft part (rotary shaft 21 and its bearing housing 2).

The turbine 3 has, inside a turbine housing 4, a turbine impeller 5 that rotates by receiving exhaust air from an unillustrated internal combustion engine.

Also, the compressor 6 has a compressor impeller 8 inside a compressor housing 7.

The rotary shaft 21 is a bar-like shaft that couples the shaft of the turbine impeller 5 and the shaft of the compressor impeller 8, and is supported by bearings 22 inside the bearing housing 2.

The turbine housing 4 has a scroll passageway 42 arranged in such a manner as to surround the outer periphery of the turbine impeller 5, between an exhaust intake part (not shown) as an exhaust inlet and an exhaust part 44 as an outlet. The scroll passageway 42 has an exhaust passageway 45 as a gas inlet passage leading to the turbine impeller 5.

The scroll passageway 42 of this example is arranged particularly to surround the outer periphery of the turbine impeller 5 as mentioned above, and is formed as a single gas circulation passage that does not have a separate wall or the like on the inner side thereof.

The turbine impeller 5 is arranged in a tubular turbine impeller housing 43 surrounded by the scroll passageway 42, and an annular exhaust passageway 45 that connects the scroll passageway 42 and the base end side of the turbine impeller housing 43 is provided. Multiple blade-shaped nozzle vanes 46 are provided in the exhaust passageway 45, in such a manner as to surround the base end side of the turbine impeller housing 43 at regular intervals along the circumferential direction of the rotary shaft 21, at a predetermined angle to the circumferential direction. Additionally, a part near the outlet of the nozzle vanes 46 forms a shroud part 47. The exhaust passageway 45 and the nozzle vanes 46 constitute an exhaust supply part 49 that supplies exhaust air as a working fluid to the turbine impeller 5.

The compressor 6 includes: the compressor housing 7 that constitutes a part of an intake passage of the internal combustion engine; and the compressor impeller 8 and diffuser 9 provided inside the compressor housing 7.

The compressor housing 7 has: a tubular compressor impeller housing 72 that has, on its tip end side, an intake suction part 71 connected to an intake pipe (not shown) of the internal combustion engine; an annular scroll passageway 73 formed in such a manner as to surround the compressor impeller housing 72; and an annular intake passageway 74 that connects the base end side of the compressor impeller housing 72 and the scroll passageway 73.

The compressor impeller 8 is provided in a rotatable manner inside the compressor impeller housing 72, while being coupled to the other end side or the rotary shaft 21. The diffuser 9 is formed into a disk shape, and is provided in the intake passageway 74. The diffuser 9 compresses intake air, by decelerating the intake air that is discharged from the base end side of the compressor impeller housing 72 to the scroll passageway 73 in the direction of centrifugal force of the rotary shaft 21.

The turbocharger 1 having the above-mentioned configuration acts in the following manner, and supercharges intake air by using energy of exhaust air of the internal combustion engine.

First, exhaust air of the internal combustion engine is introduced into the scroll passageway 42 from the exhaust intake part (not shown). The exhaust air that is given a swirl by passing through the scroll passageway 42 is allowed into the base end side of the turbine impeller housing 43 at a predetermined angle by the nozzle vanes 46, rotates the turbine impeller 5, and is discharged from the exhaust part 44 on the downstream side of the turbine impeller housing 43. Rotation of the turbine impeller 5 is transmitted by the rotary shaft 21 to the compressor impeller 8, and rotates the compressor impeller 8 inside the compressor impeller housing 72. Intake air introduced into the compressor impeller housing 72 through the intake suction part 71 by the rotation of the compressor impeller 8, is discharged toward the scroll passageway 73 from the base end side of the compressor impeller 8 in the direction of centrifugal force. The intake air discharged from the compressor impeller 8 spreads while being decelerated by the diffuser 9, and is thereby compressed. The compressed intake air flows through the scroll passageway 73, and is introduced into an intake port of the unillustrated internal combustion engine.

(Turbine Impeller of Turbomachine as One Embodiment of Present Invention)

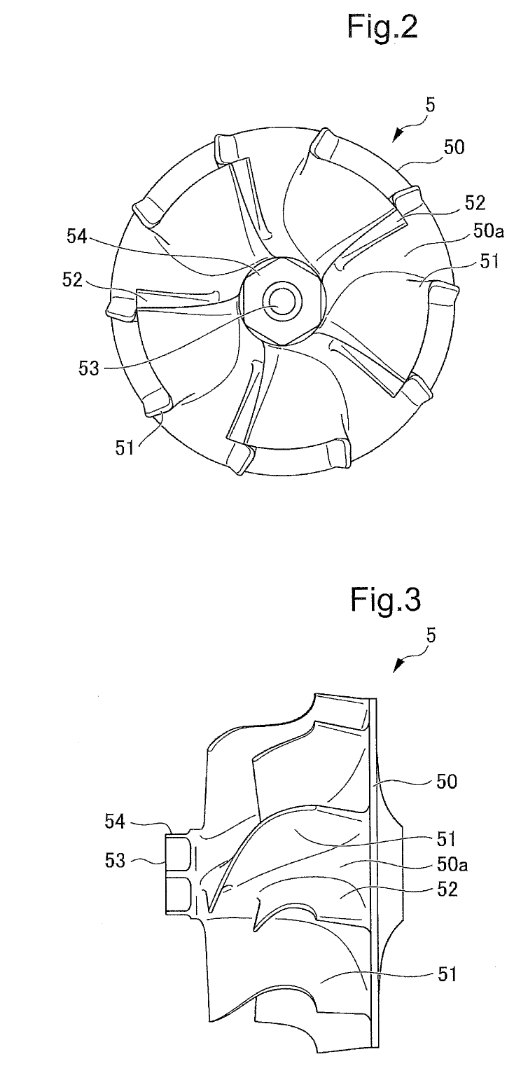

Next, a configuration of the turbine impeller 5 will be described with reference to FIGS. 2, 3, and 4.

FIG. 2 is a plan view showing an example of a turbine impeller of the turbomachine 1 of FIG. 1.

FIG. 3 is a side view of the turbine impeller of FIG. 2 from a viewpoint where one splitter is placed at the center.

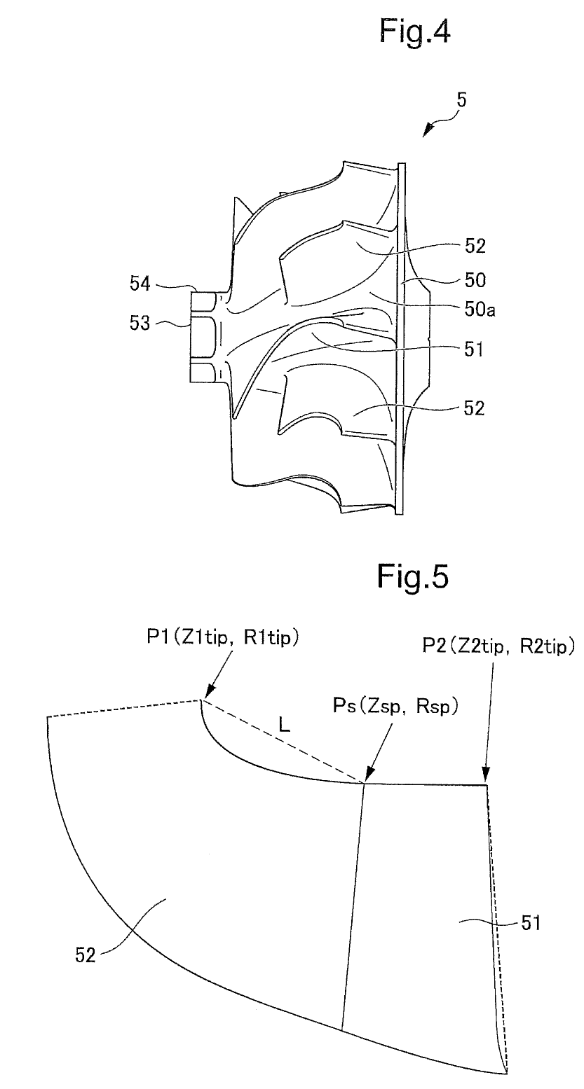

FIG. 4 is a side view of the turbine impeller of FIG. 2 from a viewpoint where one main blade is placed at the center.

As can be seen particularly from the plan view of FIG. 2, the turbine impeller 5 has multiple (five in this example) main blades 51 arranged in the circumferential direction, and also splitters 52 arranged between adjacent main blades 51, on a hub surface 50a of a hub 50, and is fixed to one end of the rotary shaft 21 by a boss part 53 at the center. The boss part 53 has a polygonal bolt-like head part 54.

As shown in FIGS. 2 to 4, as compared to the main blade 51 extending from the front edge (a blade first edge) to the rear edge (a blade second edge), the splitters 52 do not extend from the front edge to the rear edge, but extends from the front edge (a splitter first edge) to an intermediate position (a splitter second edge).

The turbine impeller 5 of the turbocharger 1 as a turbomachine of the embodiment appropriately defines the arrangement and dimension of the splitter 52 relative to the main blade 51. In the specification, “arrangement” is a concept that includes the number of blades as one element, and the same applies hereinafter.

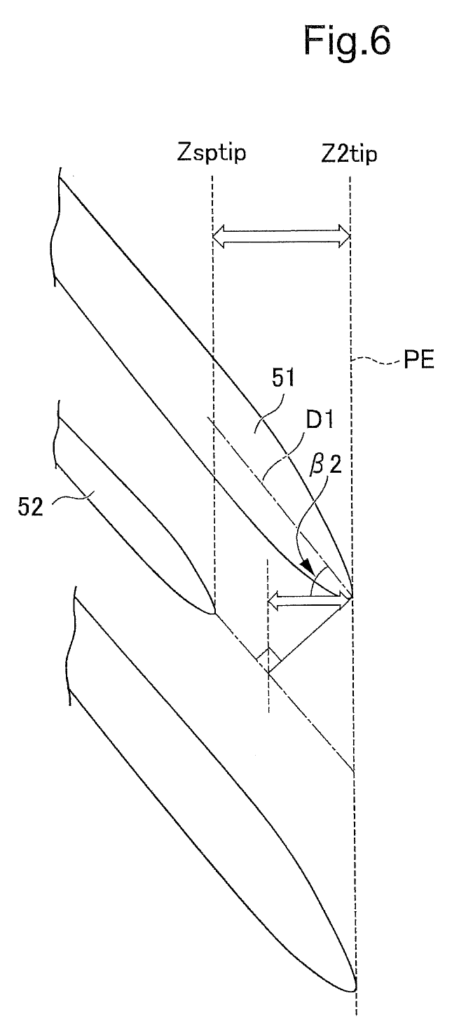

Next, a more detailed description will be given of the turbine impeller 5, by referring to FIGS. 5 and 6 in addition to the aforementioned FIGS. 1 to 4.

FIG. 5 is a view of a meridional cross-section of the turbine impeller of FIG. 2.

FIG. 6 is a view of a partial cross-section of the turbine impeller of FIG. 2.

In the turbine impeller 5, the front edge of the main blade 51 and the front edge of the splitter 52 are arranged in aligned positions on the outer circumference of the turbine impeller 5 at regular intervals in the circumferential direction, their tips are both in position P1 (Z1tip, R1tip), the rear edge of the main blade 51 is in position P2 (Z2tip, R2tip), the rear edge of the splitter 52 is in position Ps (Zsp, Rsp), and a chord length L between the position P1 and position Ps described above in a meridional cross-section is expressed by the following formula (1).

L={square root over ((R1tip−Rsp)²+(Z1tip−Zsp)²))} (1)

When the number of blades which is a total of the number of main blades (five in this example) and the number of splitters (five in this example) is N (10 in this example), “Solidity” defined by the following formula (2) satisfies the relation of the inequality sign in the formula (2).

$$Solidity = \frac{N \cdot L}{π ( R 1 tip + Rsp )} > 0.6 \qquad ( 2 )$$

That is, “Solidity” corresponds to a value obtained by dividing the length of the blade of the splitter by an interblade distance, and this value is not less than a certain value (not less than 0.6).

Moreover, when an angle between a virtual surface perpendicular to an enveloping surface PE of the rear edge tip end positions Z2tip of the rear edges of multiple main blades 51 and a chordwise direction D1 of the main blade 51 is β2, a rear edge position Zsptip of the splitter is within an area that satisfies the following formula (3).

$$\frac{Z 2 tip - Zsptip}{2 π \cdot R 2 tip / N \cdot sin β 2 \cdot cos β 2} > 1 \qquad ( 3 )$$

Also, in this example, the angle β2 in formula (3) is set within 65 degrees to 75 degrees, and satisfies the following formula (4).

$$\frac{Z 2 tip - Zsptip}{2 π \cdot R 2 tip / N} > 0.383 \qquad ( 4 )$$

Next, effects of the turbomachine 1 of the embodiment, and particularly effects of the turbine 3 will be described.

In the embodiment, the arrangement and dimension of the splitter 52 relative to the main blade 51 in the turbine impeller 5 are defined by the relations of the aforementioned formulae (1) to (4). As mentioned earlier, in the specification, “arrangement” is a concept that includes the number of blades as one element.

The reason of defining the arrangement and dimension of the splitter 52 relative to the main blade 51 by the relations of the aforementioned formulae (1) to (4) is as follows. Specifically, one requirement in determining the arrangement of the splitter 52 is to maximize the effect of controlling (straightening) the flow of exhaust air, while keeping the main blade 51 and the splitter 52 from forming a throat. According to various experiments and studies, the inventors have found that the above requirement can be met when the arrangement and dimension of the splitter 52 relative to the main blade 51 satisfy the relations of the aforementioned formulae (1) and (2).

In the turbomachine 1 of the embodiment, the arrangement and dimension of the splitter 52 relative to the main blade 51 are defined such that they satisfy the relations of the aforementioned formulae (1) and (2), and more specifically, satisfy the relations of the aforementioned formulae (3) and (4).

As a result, the main blade 51 and the splitter 52 do not form a narrow throat, so that a sufficient choke margin can be obtained. Hence, the turbocharger 1 can perform highly efficient operation in a wide flow rate range of exhaust air.

Furthermore, since the splitter 52 has a short blade length from its front edge to rear edge as compared to the main blade 51, the moment of inertia of the whole turbine impeller 5 is small. Hence, the inertia of the turbocharger 1 is lowered, so that turbo lag can be suppressed and an agile response characteristic can be achieved.

In this case, particularly in the turbocharger 1 as a turbomachine of the embodiment, the scroll passageway 42 provided in such a manner as to surround the periphery of the turbine impeller 5 forms a single gas circulation passage, that has the exhaust passageway 45 as a gas inlet passage leading to the turbine impeller 5.

Hence, instead of a complex form that includes a wall, tends to become heavy, and is difficult to manufacture, the scroll passageway 42 has a simple configuration that can be easily reduced in weight, can be easily manufactured, and can reduce manufacturing cost. Accordingly, the whole turbocharger 1 as a turbomachine has a simple configuration, can be easily reduced in weight, and can reduce manufacturing cost.

The following is a summary of the effects of the above-mentioned turbomachine of the embodiment.

(1) The turbocharger 1 as a turbomachine has: the main blade 51 that extends from a predefined front edge to rear edge; and the splitter 52 that has its own front edge position aligned with that of the main blade 51, extends from the own front edge position to an intermediate position that does not reach the rear edge position of the main blade 51, and ends at its own rear edge. Multiple main blades 51 and splitters 52 are arranged alternately in the circumferential direction. Hence, the moment of inertia is reduced as compared to a turbine impeller in which all of the main blades are normal. In other words, the inertia is lowered, so that turbo lag can be suppressed and an agile response characteristic can be achieved. In addition, the throat area on the downstream side can be enlarged and a larger choke margin can be achieved, as compared to the case in which all of the main blades are normal. Hence, a wide flow rate range can be achieved even when configured as a single stage-turbocharger. This achieves a characteristic that the turbine efficiency is less likely to deteriorate, even when the rate of exhaust flow supplied to the exhaust turbine part varies largely. Also, in particular, the scroll passageway 42 of the turbine housing 4 is arranged in such a manner as to surround the outer periphery of the turbine impeller 5 between an exhaust inlet (not shown) and an outlet (exhaust part 44), and forms a single gas circulation passage having a gas inlet passage (exhaust passageway 45) leading to the turbine impeller 5. Hence, the configuration is simple and can be reduced in size and weight. Moreover, since the configuration is simple, manufacturing cost can be reduced.

(2) In the turbocharger 1 as a turbomachine, particularly in the turbine impeller 5, representative tip positions of the front edges of the main blade 51 and the splitter 52 are aligned at position P1 (Z1tip, R1tip), a representative position of the rear edge of the splitter 52 is position Ps (Zsp, Rsp), and a splitter blade length L, which is a distance between the position P1 and position Ps, and a representative length of the splitter 52 in a meridional cross-section, is expressed by the aforementioned formula (1).

When the number of blades which is a total of the number of main blades 51 and the number of splitters 52 is N, Solidity defined by the aforementioned formula (2) satisfies the relation of the inequality sign in the formula (2).

That is, “Solidity” corresponds to a value obtained by dividing the length of the blade of the splitter 52 by an interblade distance, and this value is not less than a certain value (not less than 0.6).

Furthermore, in the turbocharger 1 as a turbomachine, particularly, when an angle between a virtual surface perpendicular to an enveloping surface PE of representative tip end positions Z2tip of the rear edges of multiple main blades 51, and a direction D1 from the front edge to the rear edge of the center of thickness of the main blade is β2, a rear edge position Zsptip of the splitter is within an area that satisfies the aforementioned formula (3).

Accordingly, the main blade 51 and the splitter 52 do not form a narrow throat, so that a sufficient choke margin can be obtained, and an excellent aerodynamic characteristic of the turbine impeller can be achieved. Hence, the turbocharger 1 can maintain sufficient performance for a wide flow rate range.

Further, since the splitter 52 has a short blade length from its front edge to rear edge as compared to the main blade 51, the moment of inertia of the whole turbine impeller 5 is small. Hence, the inertia of the turbocharger 1 is lowered, so that turbo lag can be suppressed and an agile response characteristic can be achieved.

(3) In the turbocharger 1 as a turbomachine, particularly the angle β2 in formula (3) is set within 65 degrees to 75 degrees, and satisfies the aforementioned formula (4).

Hence, the main blade 51 and the splitter 52 do not form a narrow throat, so that a sufficient choke margin can be obtained, and therefore the turbocharger 1 can perform highly efficient operation in a wide flow rate range of exhaust air.

Furthermore, since the splitter 52 has a short blade length from its front edge to rear edge as compared to the main blade 51, the moment of inertia of the whole turbine impeller 5 is small. Hence, the inertia of the turbocharger 1 is lowered, so that turbo lag can be suppressed and an agile response characteristic can be achieved.

While the turbocharger as a turbomachine of the embodiment described above can achieve a wide flow rate range even when configured as a single stage-turbocharger, turbochargers formed in the above-mentioned manner may be connected in series to configure a two-stage turbocharger instead.

Moreover, other variations and modifications not departing from the gist of the present invention are included in the scope of the present invention.

For example, the turbomachine of the present invention is not limited to being implemented as a turbocharger of an internal combustion engine as described above, and even when implemented as an engine of an aircraft or a motor of an industrial generator, the inertia of the whole turbine impeller can be lowered, so that an agile response characteristic can be achieved, and also cost can be reduced as mentioned above. Also, in particular, the scroll passageway of the turbine housing is arranged in such a manner as to surround the outer periphery of the turbine impeller between an exhaust inlet and outlet, and forms a single gas circulation passage having a gas inlet passage leading to the turbine impeller. Hence, the configuration is simple and can be reduced in size and weight. Moreover, since the configuration is simple, manufacturing cost can be reduced.

According to the embodiments of the present invention, (1) A turbomachine including a turbine impeller (e.g., later-mentioned turbine impeller 5) inside a turbine housing (e.g., later-mentioned turbine housing 4), in which: the turbine impeller has a main blade (e.g., later-mentioned main blade 51) that extends from a predefined front edge to rear edge, and a splitter (e.g., later-mentioned splitter 52) that has its own front edge position aligned with the front edge position of the main blade, extends from the own front edge position to an intermediate position that does not reach the rear edge position of the main blade, and ends at its own rear edge, multiple main blades and splitters being arranged alternately in the circumferential direction; and the turbine housing has a scroll passageway (e.g., later-mentioned scroll passageway 42) that is arranged in such a manner as to surround the outer periphery of the turbine impeller between an exhaust inlet (not shown) and outlet (e.g., later-mentioned exhaust part 44), and that forms a single gas circulation passage having a gas inlet passage (e.g., later-mentioned exhaust passageway 45) leading to the turbine impeller.

In the turbomachine of (1), the turbine impeller has: the main blade that extends from a predefined front edge to rear edge; and the splitter that has its own front edge position aligned with that of the main blade, extends from the own front edge position to an intermediate position that does not reach the rear edge position of the main blade, and ends at its own rear edge. Multiple main blades and splitters are arranged alternately in the circumferential direction. Hence, the moment of inertia is reduced as compared to a turbine impeller in which all of the main blades are normal, so that turbo lag can be suppressed and an agile response characteristic can be achieved. In addition, the throat area on the downstream side can be enlarged and a larger choke margin can be achieved, as compared to the case in which all of the main blades are normal. Hence, a wide flow rate range can be achieved even when configured as a single stage-turbomachine. This achieves a characteristic that the turbine efficiency is less likely to deteriorate, even when the rate of exhaust flow supplied to the exhaust turbine part varies largely. Also, in particular, the scroll passageway of the turbine housing is arranged in such a manner as to surround the outer periphery of the turbine impeller between an exhaust inlet and outlet, and forms a single gas circulation passage having a gas inlet passage leading to the turbine impeller. Hence, the configuration is simple and can be reduced in size and weight. Moreover, since the configuration is simple, manufacturing cost can be reduced.

(2) The turbomachine described in (1), in which: in the turbine impeller, front edge tip positions of the main blade and the splitter are both P1 (Z1tip, R1tip), a rear edge tip position of the main blade is P2 (Z2tip, R2tip), a rear edge tip position of the splitter is Ps (Zsp, Rsp), and a chord length L between the position P1 and position Ps in a meridional cross-section is expressed by the following formula (1);

L={square root over ((R1tip−Rsp)²+(Z1tip−Zsp)²))} (1)

when the number of blades which is a total of the number of the main blades and the number of the splitters is N, Solidity defined by the following formula (2) satisfies the relation of the inequality sign in the formula (2);

$$Solidity = \frac{N \cdot L}{π ( R 1 tip + Rsp )} > 0.6 \qquad ( 2 )$$

and

when an angle (inferior angle) between a virtual surface perpendicular to an enveloping surface of the rear edge tip end positions Z2tip of the plurality of main blades and a chordwise direction of the main blade is β2, each rear edge position Zsptip of the plurality of splitters is within an area that satisfies the following formula (3).

$$\frac{Z 2 tip - Zsptip}{2 π \cdot R 2 tip / N \cdot sin β 2 \cdot cos β 2} > 1 \qquad ( 3 )$$

In the turbomachine of (2), particularly in the turbomachine of (1), the main blade and the splitter do not form a narrow throat while the splitter effectively straightens the exhaust flow, so that a sufficient choke margin can be obtained, and an excellent aerodynamic characteristic of the turbine impeller can be achieved. Hence, sufficient performance can be maintained for a wide flow rate range.

(3) The turbomachine of (1) or (2), in which the angle β2 in the formula (3) is set within 65 degrees to 75 degrees, and satisfies the following formula (4).

$$\frac{Z 2 tip - Zsptip}{2 π \cdot R 2 tip / N} > 0.383 \qquad ( 4 )$$

In the turbomachine of (3), particularly in the turbomachine of (2), an excellent aerodynamic characteristic of the turbine impeller can be achieved.

### [Effect of the Invention]

According to the embodiments of the present invention, it is possible to implement a turbomachine that can be easily reduced in size and weight, and reduces manufacturing cost, while having an agile response characteristic.

Obviously, numerous modifications and variations of the present invention are possible in light of the above teachings. It is therefore to be understood that within the scope of the appended claims, the invention may be practiced otherwise than as specifically described herein.

What is claimed is:

1. A turbomachine comprising a turbine impeller inside a turbine housing, wherein:
the turbine impeller has
a main blade that extends from a predefined front edge to rear edge, and
a splitter that has its own front edge position aligned with the front edge position of the main blade, extends from the own front edge position to an intermediate position that does not reach the rear edge position of the main blade, and ends at its own rear edge, a plurality of the main blades and the splitters being arranged alternately in a circumferential direction; and
the turbine housing has a scroll passageway that is arranged in such a manner as to surround the outer periphery of the turbine impeller between an exhaust inlet and outlet, and that forms a single gas circulation passage having a gas inlet passage leading to the turbine impeller.

2. The turbomachine according to claim 1, wherein:
in the turbine impeller, front edge tip positions of the main blade and the splitter are both P1 (Z1tip, R1tip), a rear edge tip position of the main blade is P2 (Z2tip, R2tip), a rear edge tip position of the splitter is Ps (Zsp, Rsp), and a chord length L between the position P1 and position Ps in a meridional cross-section is expressed by the following formula (1);
L={square root over ((R1tip−Rsp)²+(Z1tip−Zsp)²))} (1)
when the number of blades which is a total of the number of the main blades and the number of the splitters is N, Solidity defined by the following formula (2) satisfies the relation of the inequality sign in the formula (2);
$$Solidity = \frac{N \cdot L}{π ( R 1 tip + Rsp )} > 0.6 \qquad ( 2 )$$
and
when an angle (inferior angle) between a virtual surface perpendicular to an enveloping surface of the rear edge tip end positions Z2tip of the plurality of main blades and a chordwise direction of the main blade is β2, each rear edge position Zsptip of the plurality of splitters is within an area that satisfies the following formula (3),
$$\frac{Z 2 tip - Zsptip}{2 π \cdot R 2 tip / N \cdot sin β 2 \cdot cos β 2} > 1. \qquad ( 3 )$$

3. The turbomachine according to claim 2, wherein
the angle β2 in the formula (3) is set within 65 degrees to 75 degrees, and satisfies the following formula (4),
$$\frac{Z 2 tip - Zsptip}{2 π \cdot R 2 tip / N} > 0.383 . \qquad ( 4 )$$

4. A turbomachine comprising:
a turbine impeller having a rotational axis, a first end portion, and a second end portion opposite to the first end along the rotational axis, the turbine impeller comprising:
main blades each of which has a blade first edge provided at the first end portion and a blade second edge provided at the second end portion and which extends from the blade first edge to the blade second edge; and
splitters each of which has a splitter first edge and a splitter second edge and which extends from the splitter first edge to the splitter second edge, the blade first edge and the splitter first edge being arranged on a plane perpendicular to the rotational axis, the splitter second edge being positioned between the splitter first edge and the blade second edge along the rotational axis, the main blades and the splitters being arranged alternately in a circumferential direction around the rotational axis; and
a turbine housing accommodating the turbine impeller therein and comprising:
a scroll passageway arranged to surround an outer periphery of the turbine impeller to define a single gas circulation passage leading to the turbine impeller.

5. The turbomachine according to claim 4, wherein
in the turbine impeller, tip positions of the blade first edge and the splitter first edge are both P1 (Z1tip, R1tip), a tip position of the blade second edge is P2 (Z2tip, R2tip), a tip position of the splitter first edge is Ps (Zsp, Rsp), and a chord length L between the position P1 and the position Ps in a meridional cross-section is expressed by the following formula (1),
L={square root over ((R1tip−Rsp)²+(Z1tip−Zsp)²))} (1)
when the number of blades which is a total of the number of the main blades and the number of the splitters is N, Solidity defined by the following formula (2) satisfies the relation of the inequality sign in the formula (2),
$$Solidity = \frac{N \cdot L}{π ( R 1 tip + Rsp )} > 0.6 \qquad ( 2 )$$
and
when an angle (inferior angle) between a virtual surface perpendicular to an enveloping surface of the tip position Z2tip of each of the blade second edges and a chordwise direction of the main blade is β2, an edge position Zsptip of each of the splitter second edges is within an area that satisfies the following formula (3),
$$\frac{Z 2 tip - Zsptip}{2 π \cdot R 2 tip / N \cdot sin β 2 \cdot cos β 2} > 1. \qquad ( 3 )$$

6. The turbomachine according to claim 5, wherein
the angle β2 in the formula (3) is set within 65 degrees to 75 degrees, and satisfies the following formula (4),
$$\frac{Z 2 tip - Zsptip}{2 π \cdot R 2 tip / N} > 0.383 . \qquad ( 4 )$$

7. The turbomachine according to claim 4, wherein the scroll passageway is arranged between an exhaust inlet and an exhaust outlet.
